(19) United States
(12) Patent Application Publication
(10) Pub. No.: US 2006/0095436 A1
(43) Pub. Date: May 4, 2006

(54) Networked document partially printing system and method

(76) Inventor: Yoshihiko Abe, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/258,893

(22) Filed: Oct. 27, 2005

(30) Foreign Application Priority Data
Oct. 27, 2004 (JP) 2004-312823

(51) Int. Cl. G06F 17/30

(52) U.S. Cl. 707/10

(57) ABSTRACT

A networked printing system includes an electronic document server having a database that stores a plurality of electronic documents of books, which are uniquely identified by a plurality of identification codes, respectively. The electronic document server specifies and allows downloading of a prescribed electronic document matched with an identification code received. A transmitting device is provided to transmit a request for a prescribed electronic document and a corresponding identification code to the electronic document server via a network. A printing device connected to the electronic server document prints a portion of the electronic document in accordance with designation of pages.

### CROSS REFERRENCE TO RELATED APPLICATION

This application claims priority under 35 USC §119 to Japanese Patent Application No. 2004-312823 filed on Oct. 27, 2004, the entire contents of which are hereby incorporating by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of The Invention

The present invention relates to a networked printing system and method using an image forming apparatus capable of receiving and printing an electronic document stored in a server over a network, and in particular, to a networked printing system and method using an image forming apparatus capable of receiving and printing a prescribed portion of an electronic document.

2. Discussion of the Background Arts

As a copier that reads and prints a sheet document, a scanner apparatus that pressure-contacts and reads documents on a glass surface one by one is known. Also known apparatus is an auto document feeder (ADF) that separates, feeds, and reads a plurality of bunchy sheets one by one.

A contact type scanner apparatus can only read a bind document. Also known apparatus is a bind book reading apparatus capable of automatically turning pages thereof using static electricity as discussed in Japanese Patent Application Laid Open No. 09-211901.

A system capable of printing an electronic document before bookbinding is proposed as discussed in Japanese Patent Application Laid Open No. 11-328526. The system is enabled such that an electronic document is downloaded from a document database that stores electronic documents via a network, and a printer having a book binding function executes binding.

Since a price is set per book and a book is sold in a unit in general, the entire an electronic document of one book is always entirely downloaded from a book data server even if only a prescribed portion is requested.

### SUMMARY OF THE INVENTION

Accordingly, an object of the present invention is to improve such background arts technologies and provides a new and novel networked printing system including an electronic document server including a database for storing a plurality of electronic documents of books, uniquely identified by a plurality of identification codes, respectively. On one embodiment, the electronic document server specifies and allows downloading of a prescribed electronic document that matches with an identification code received. A reading device is provided to read identification information included in a book. A conversion device is provided to convert the identification information into a corresponding identification code. A portion designating device is provided to designate a portion of the book. A memory is provided to store information of the portion. A transmitting device is provided to transmit a request for a prescribed electronic document and a corresponding identification code to the electronic document server via a network. A reception device is provided to receive an electronic document specified and transmitted from the electronic document server. A printing device is provided to print a portion of the electronic document corresponding to the portion designated by the portion designating device.

In another embodiment, the electronic document server partially specifies and allows downloading of a prescribed portion of an electronic document matching with a portion designation information and an identification code, which is generated and transferred from a portion designation information generating device and the transmitting device.

In yet another embodiment, the portion designating device includes ten-pad keys provided in the printing device.

In yet another embodiment, the reading device serves as the portion designation information generating device by reading portion designation information from the book.

In yet another embodiment, the electronic document server specifies the electronic document by referring to header information of each of the plurality of electronic documents.

In yet another embodiment, the electronic document server specifies the portion of the electronic document by referring to header information of each of the plurality of electronic documents.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates a system according to one embodiment of the present invention;

FIG. 2 illustrates an exemplary digital copier according to one embodiment of the present invention;

FIG. 3 illustrates exemplary identification information that uniquely specifies a book;

FIG. 4 illustrates exemplary information stored in database included in an electronic document server;

FIG. 5 illustrates exemplary data stream of an electronic document from an electronic document server to a printer control section via a controller of the digital copier when the book is to be entirely copied;

FIG. 6 illustrates another exemplary identification information that uniquely specifies a part of a book;

FIG. 7 illustrates an exemplary operation panel for designating a copy area of the document;

FIG. 8 illustrates exemplary data stream of an electronic document from the electronic document server to the printer control section via the controller of the digital copier when a book is to be partially copied;

FIG. 9 illustrates an exemplary sequential operation of a digital copier when the book is to be partially copied;

FIG. 10 illustrates an exemplary sequential operation of the electronic document server when a book is to be partially copied;

FIG. 11 illustrates another exemplary data stream of an electronic document from the electronic document server to the printer control section via the controller of the digital copier when a book is to be partially copied;

FIG. 12 illustrates another exemplary sequential operation of the digital copier shown in FIG. 11; and

FIG. 13 illustrates an exemplary sequential operation of the electronic document server shown in FIG. 11.

### DESCRIPTION OF THE PREFERRED EMBODIMENTS

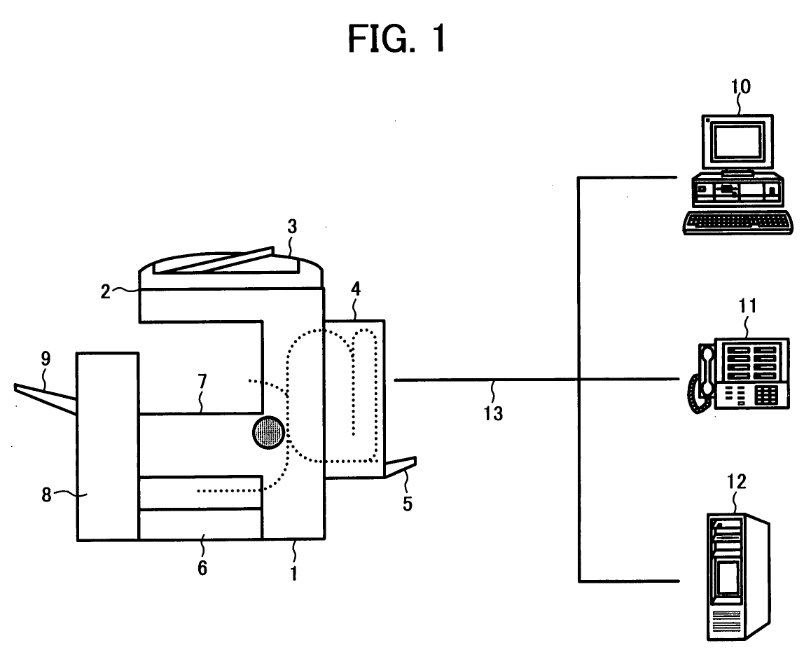

Referring now to the drawing, wherein like reference numerals designate identical or corresponding parts throughout several views, in particular in FIG. 1, an exemplary digital copier is illustrated. The digital copier includes a copier body 1, a contact type reading apparatus 2 that reads a document set thereto, an auto document feeder (ADF) 3 that feeds and reads a plurality of documents in turn, a duplex reversal sheet ejection unit 4 that reverses a printing surface, a manual sheet feeding tray 5 that allows manual setting of a sheet upon need, a sheet feeding tray 6 that accommodates and allows setting of commonly used sheets, a body sheet ejection tray 7 that ejects a sheet after printing, a finisher apparatus 8 that applies punching or similar processing to the printed sheet, and a finisher ejection tray 9 that ejects the printing sheet passing through the finisher apparatus 8.

The copier body 1 includes a scanner section, a writing section, a photoconductive member section, a developing section, a fixing section, a transfer section, and a sheet feeding section, or the like, and achieves a copying function or the like by controlling these sections to cooperate. The digital copier includes a multifunction, such as copying, printing, sending facsimile, etc. Thus, the digital copier executes image formation upon request of scanning or printing from a personal computer (PC) 10, or that of printing from a fax apparatus 11, through a plurality of networks 13, such as an Internet, a telephone line, etc. Further, the digital copier reads and stores image data in an electronic document server 12 over the network 13 through the reading apparatus 2, and reads and prints the image data stored.

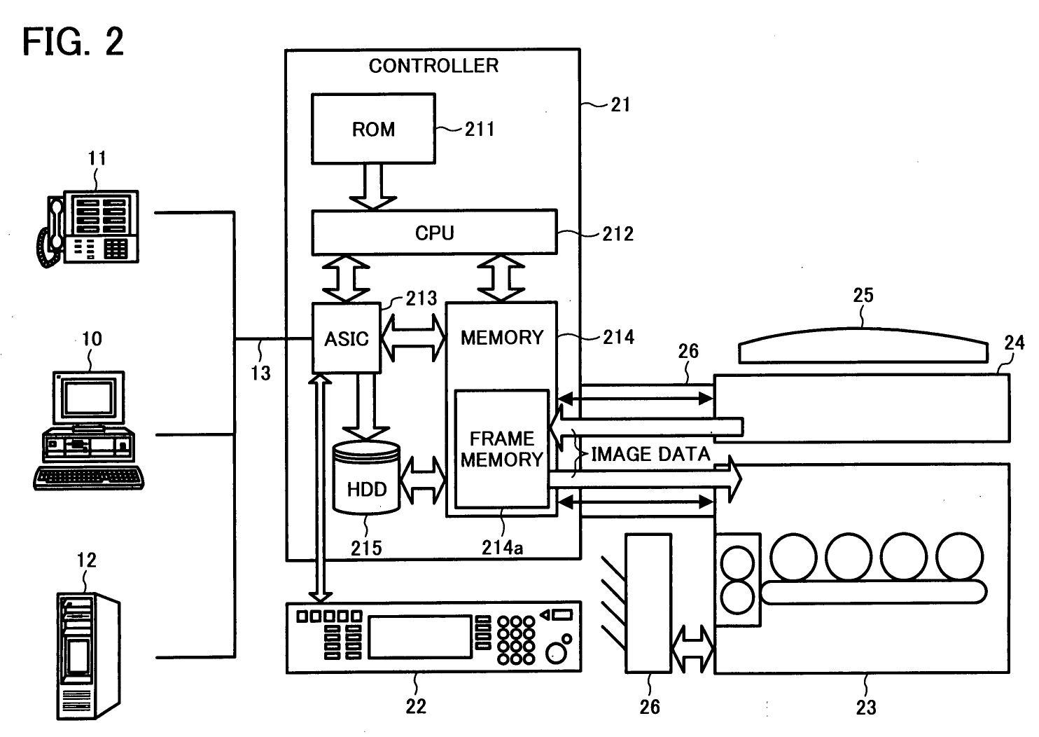

Now, an exemplary construction of the digital copier is described with reference to FIG. 2. A controller 21 generally controls the digital copier and is connected to an operation section control section 22, a printer control section 23, and a scanner control section 24. A DF (document feeder) control section 25 is connected to the scanner control section 24. A finisher control section 26 is connected to the printer control section 23. The scanner control section 24 includes an image processing section (not shown).

A controller 21 includes a ROM 211 that stores control program, a CPU 212 that executes various processing, an ASIC (Application Specific Integrated Circuit) 213 that executes various processing, a memory 214 used in executing program and used as a frame memory 214a for image data, and an HDD apparatus 215 that stores massive image data. The ASIC 213 interfaces with the operation section control section 22 and the network 13, and is capable of communicating command and image data with the scanner control section 24 and the printer control section 23 via the memory 214. Data read from the sheet document by the scanner control section 24 is converted into an electronic document, and is then stored in the memory 214 or the HDD apparatus 215. The ASIC 213 determines presence and extracts abstract information from the data. The CPU 212 interprets contents of the bibliographic information, and applies necessary processing.

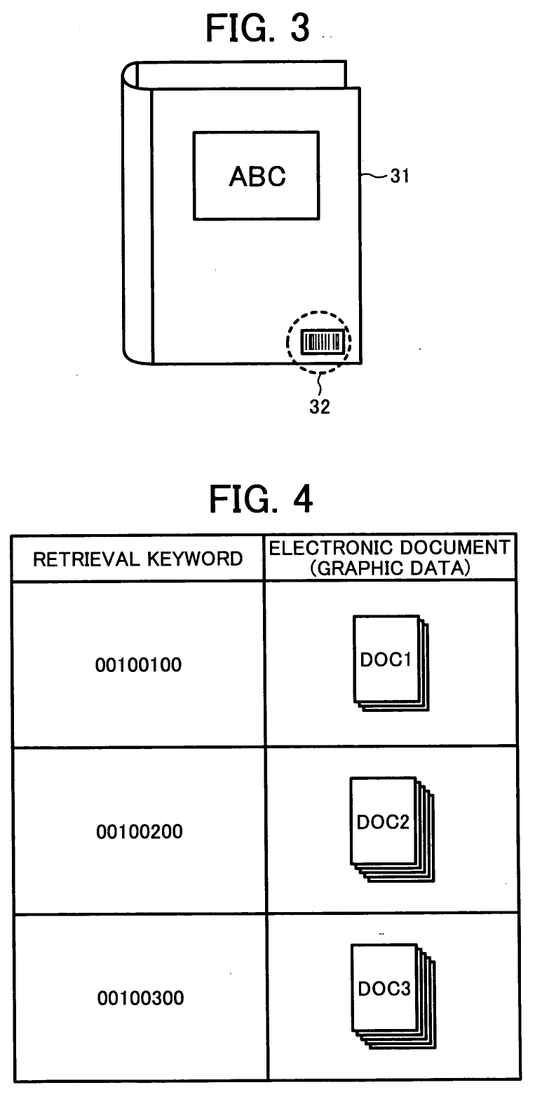

In order to uniquely specify an electronic document of a book as a copying objective, graphic data as an exemplary bibliographic information is previously printed on each of books in this example. Specifically, as shown in FIG. 3, a bar code 32 is previously printed on the surface of a bind book 31 and is read to specify a corresponding electronic document. The electronic document server 12 maintains bibliographic information, such as a digitalized retrieval keyword, etc., and a corresponding electronic document in a manner as shown in FIG. 4 as database so as to allow retrieval based on a designated keyword.

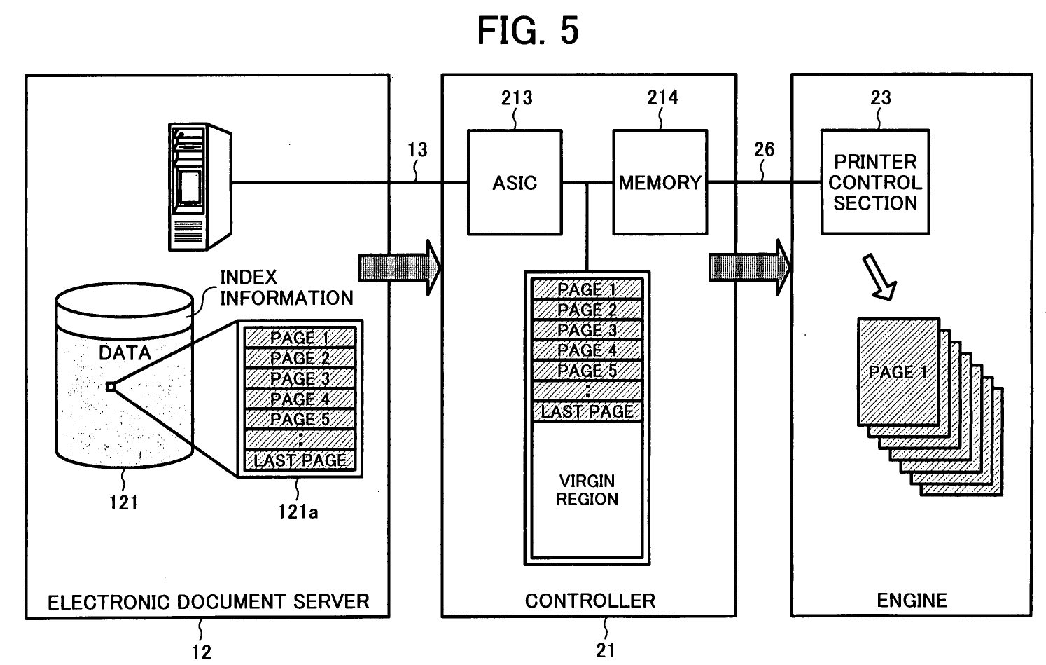

Now, an exemplary operation executed when a digital copier obtains and copies a book is described with reference to FIG. 5.

As shown, a user executes reading of bibliographic information (i.e., a bar code 32) of a book 3 using the reading apparatus 2. The electronic document read is temporally stored in the memory 214 as graphic data. The ASIC 213 then retrieves the bibliographic information on the memory 214. The bibliographic information recognized by the ASIC 213 is then digitalized by the CPU 212 to be a retrieval keyword, and is transmitted to the electronic document server 12 over the network 13. As shown in FIG. 5, the electronic document server 12 retrieves the database 121 in accordance with a retrieval keyword received. When the keyword is found, the electronic document server 12 reports successful result, while transferring an applicable electronic document 121a thereto in accordance with protocol of data transfer. When the keyword is not found, the electronic document server 12 reports failure result to the digital copier.

The digital copier enters into a waiting condition waiting for a response from the electronic document server 12 during requesting for retrieval to the electronic document server 12. When the response of the electronic document server 12 indicating successful retrieval is returned, the digital copier immediately receives the electronic document in accordance with protocol. Such reception data is temporally stored in the memory 214 of the controller 21, and is transferred to the printer control section 23 though an interface 26. All of pages received are then printed in turn. When the response indicates failure of retrieval, the digital copier stops operating by regarding that obtaining of a document results in failure. However, the digital copier can stop obtaining an electronic document from the electronic document server 12 and execute printing based on electronic document read.

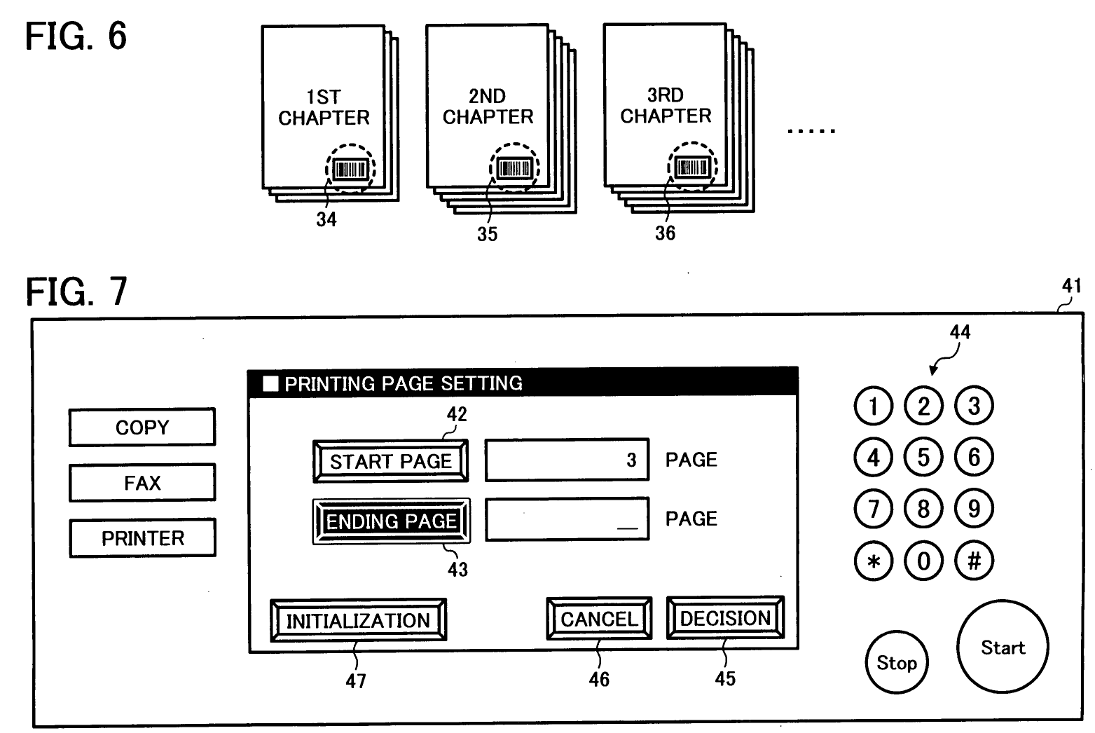

Now, an operation of partially selecting and copying a book is described with reference to FIG. 6. As a method of partially selecting contents of a book, an identification information including a factor capable of uniquely specifying a prescribed portion of the book is previously printed on the portion, and a user is required to only selectively read the identification information so as to uniquely specify the portion to be copied. Specifically, as shown in FIG. 6, a plurality of identification information 34, 35, 36 are previously printed on a book per chapter. Then, a user designates a desired chapter and reads identification information corresponding thereto using the reading apparatus 2. Otherwise, the user selects and copies a table of contents, leading respective pages of chapters, respective bibliographic of chapters, an index, end book information, and referential book information, or the like

As another method of partially selecting contents of a book, an input device such as an operation panel, etc., is used so that the user can designate a portion to obtain. For example, as shown in FIG. 7, a start page inputting key 42 and an end page inputting key 43 are displayed on the operational panel, and the user can select and input applicable start and end pages thereinto using a ten-pad key. Then, when fixing the input condition, a decision bottom 45 is depressed. When canceling the input condition, a cancel bottom 46 is depressed. When initialing the conditions, an initial button 47 is depressed. The conditions set here are temporally stored in the memory 214 and are read and referred to when identification information identifying a book is detected later.

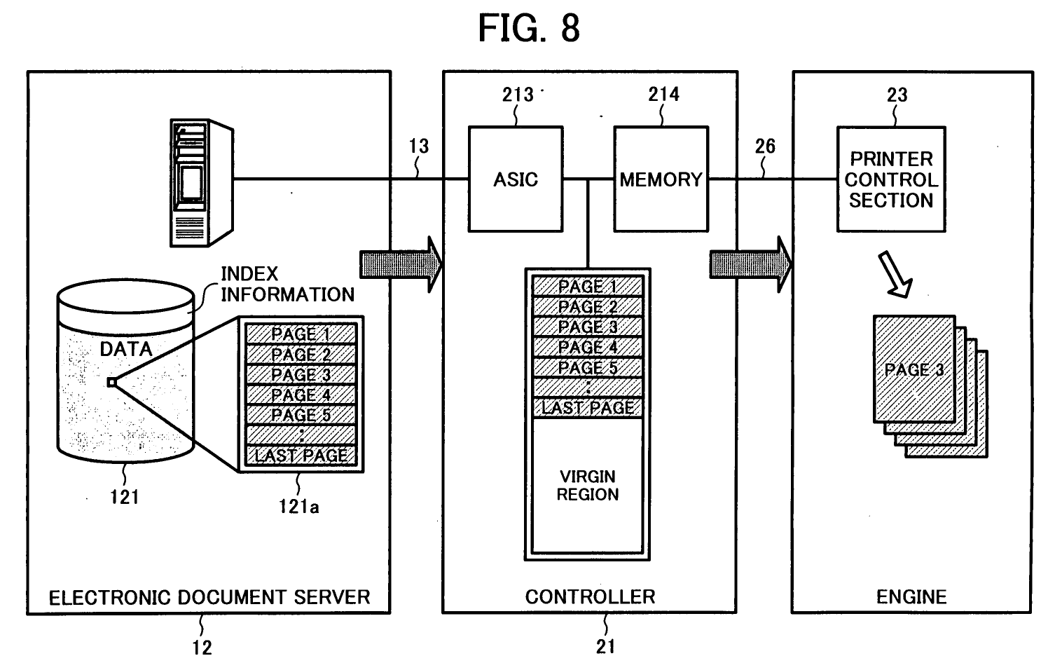

Now, an operation of partially copying a selected portion of a book is described with reference to FIGS. 8 to 10. There are two ways when a user partially select a book as mentioned below. One is to limit an electronic document into a necessary portion of the book at the site of the electronic document server 12 when transmitting thereof. Another is to limit an electronic document into a necessary portion of the book at the site of the digital copier to print out. Although there are totally four combinations, only two cases are herein below typically described.

First, a portion to copy is specified using the operation panel as shown in FIG. 7. The electronic document server 12 then transmits an electronic document of the entire pages. The digital copier then receives and prints out only the page or pages specified. Second, reading identification information in a unit of a chapter as shown in FIG. 6 specifies a portion to copy. The electronic document server 12 then transmits an electronic document of the specified portion. The digital copier then prints out the entire pages received.

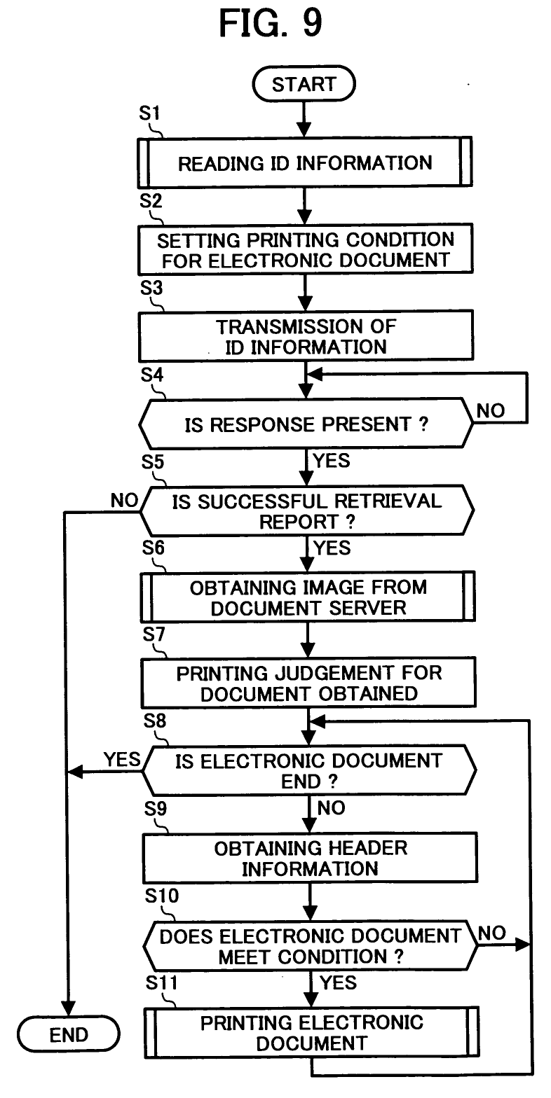

Now, data stream of the electronic document is described with reference to FIG. 9. A user reads bibliographic information (e.g. a bar code) of a book using the reading apparatus 2 in step S1. Then, he or she inputs a page range to copy though the operation panel 41 in step S2. Then, the CPU 212 creates a retrieval keyword based on the identification information read, and transmits the retrieval keyword together with a request for an image to the electronic document server 12 in step S3.

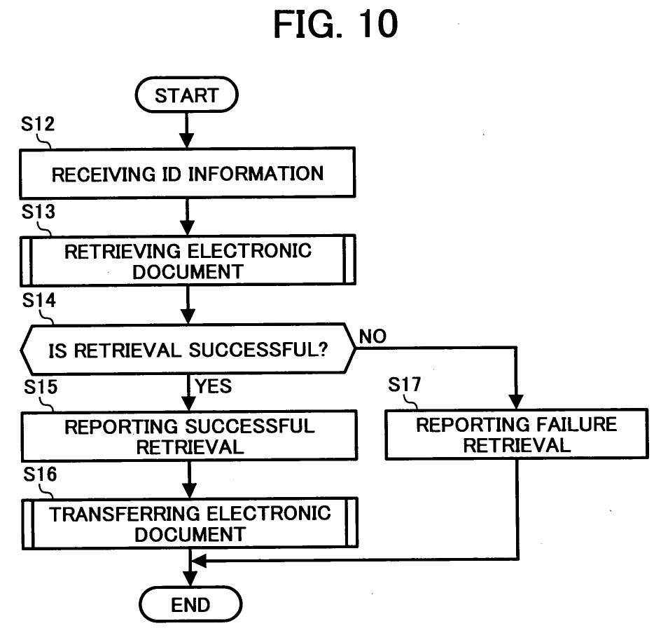

The electronic document server 12 receives the request and the identification information in step S12 shown in FIG. 10. Then, the electronic document server 12 retrieves an applicable electronic document within the database 121 in step S13. When the retrieval keyword is found (Yes, in step S14) the electronic document server 12 reports success of retrieval to the digital copier in step S15, and transmits the entire pages of the applicable electronic document 121a in accordance with protocol of data transfer in step S16. When the retrieval keyword is not found (NO, in step S14), the electronic document server 12 reports failure of retrieval to the digital copier in step S17.

The digital copier enters into a waiting state waiting a response from the electronic document server 12 during requesting retrieval thereto in step 4. When the response indicates successful retrieval (i.e., Yes, in step S5), the digital copier immediately receives the electronic document in accordance with the protocol. When the response indicates failure of the retrieval (No, in step S5) , the digital copier regards that document obtaining results in failure and stops operating.

The entire pages of the electronic document are temporally stored in the memory. The controller 21 applies printing judgment processing to the electronic document in step S7 and repeats the below described processes until the final page thereof (Yes, in step S8). Specifically, the controller extracts header information of the electronic document data (in step S9), determines if the header information meats a predetermined specified condition (e.g. if it is from pages 3 to 5 inputted by a user through the operation panel 41) (in step S10), and executes printing if the determination is positive in step S11. If the determination is negative, the controller does nothing but terminates processing after determination of the final electronic document page.

Thus, an unnecessary portion is removed from the electronic document data.

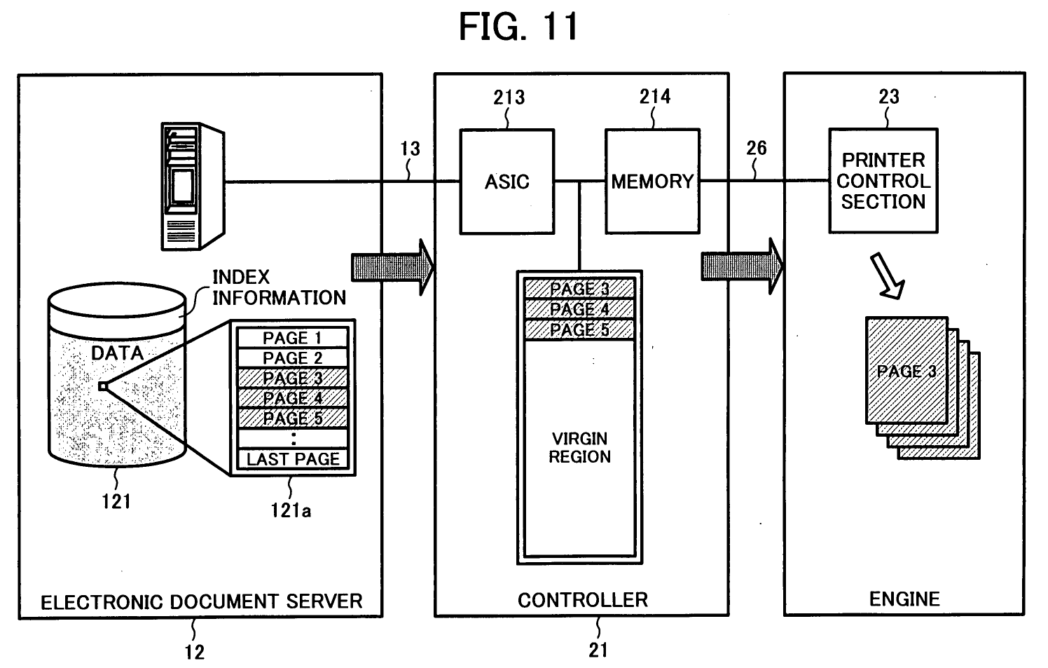

Now, another exemplary operation is described with reference to FIG. 11. An ID (see FIG. 11) is read in a unit of chapter to specify a portion top copy. Then, the electronic document server 12 only transmits a portion of an electronic document specified. The digital copier prints reception pages.

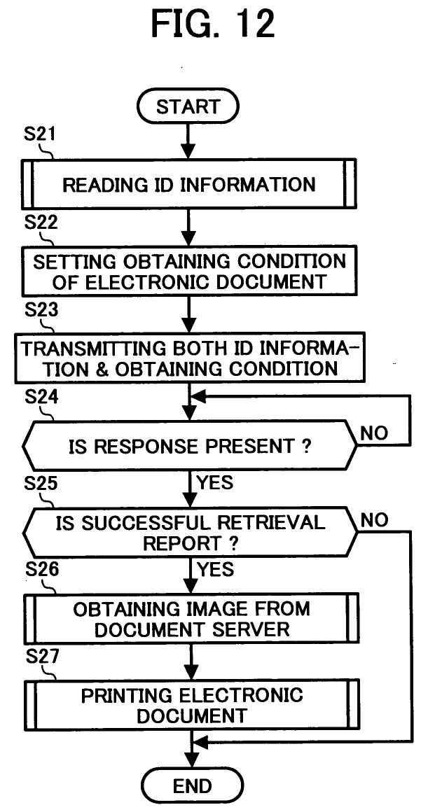

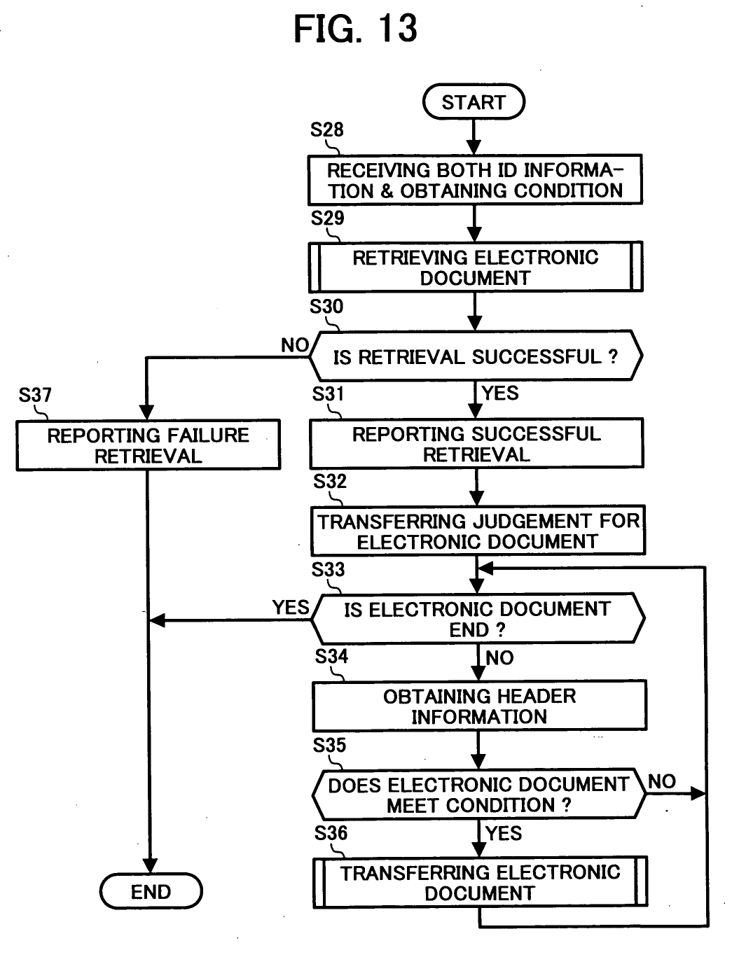

More specifically, as shown in FIG. 12, a user uses the reading apparatus 2 and reads identification information that identifies a chapter to copy in step S21. The CPU 212 creates a retrieval keyword based on the identification information and designates an electronic document obtaining condition to be requested to the electronic document server 12 in step S22. The CPU 212 then transmits a request for an image to the electronic document server 12 together with the retrieval keyword and the electronic document obtaining condition in step S23.

When receiving the request together with the retrieval keyword and the electronic document obtaining condition in step S28, the electronic document server 12 retrieves an applicable electronic document within the database 121 (Yes, in step S29) When the keyword is found in step S30, the electronic document server 12 notifies the digital copier that the retrieving results in successful in step S31. The electronic document server 12 then executes transfer judgment processing to the applicable electronic document in step S32, and repeats the following processing until the final electronic document (Yes, in step S33). Specifically, the electronic document server 12 extracts header information of the electronic document (in step S34), determines if the header information meats the obtaining condition received as a request (e.g. if it is from pages 3 to 5 as a chapter specified by the identification information read in step S21) (in step S35), and executes transfer processing if the determination is positive in step S36. If the determination is negative, the electronic document server 12 does transfer the data of the electronic document and terminates processing after determination of the final electronic document. When the keyword is not found (NO, in step S30), the electronic document server 12 reports to the digital copier that the retrieval results in failure in step S37.

The digital copier enters into a waiting state waiting a response from the electronic document server 12 during requesting for retrieval thereto. When the response is returned from the electronic document server 12 indicating successful retrieval (i.e., Yes, in step S25), the digital copier immediately receives the electronic document in accordance with the protocol. When the response from the electronic document server 12 indicates failure of the retrieval (No, in step S25) the digital copier regards that document obtaining results in failure and stops operating.

Such reception data is temporally stored in the memory 214, and is transferred to the printer control section 23 though an interface 26. Document pages received are then-printed in turn in step S27.

Numerous additional modifications and variations of the present invention are possible in light of the above teachings. It is therefore to be understood that within the scope of the appended claims, the present invention may be practiced otherwise that as specifically described herein.

What is claimed is:

1. A networked printing system, comprising:
an electronic document server including a database configured to store a plurality of electronic documents of books, said plurality of electronic documents being uniquely identified by a plurality of identification codes, respectively, said electronic document server specifying and allowing download of a prescribed electronic document matching with an identification code received;
a reading device configured to read identification information included in a book;
a conversion device configured to convert the identification information into a corresponding identification code;
a portion designating device configured to designate a portion of the book;
a memory configured to store information of the portion;
a transmitting device configured to transmit a request for a prescribed electronic document and a corresponding identification code to the electronic document server via a network;
a reception device configured to receive an electronic document specified and transmitted from the electronic document server; and
a printing device configured to print a portion of the electronic document corresponding to the portion designated by the portion designating device.

2. A networked printing system, comprising:
an electronic document server including a database configured to store a plurality of electronic documents of books, said plurality of electronic documents being uniquely identified by a plurality of identification codes, respectively, said electronic document server partially specifying and allowing download of a prescribed portion of an electronic document matching with a portion designation information and an identification code received;
a reading device configured to read identification information included in a book;
a conversion device configured to convert the identification information into a corresponding identification code;
a portion designation information generating device configured to generate a portion designation information configure to designate a portion of the book;
a transmitting device configured to transmit a request for a prescribed electronic document, a portion designation information, and a corresponding identification code to the electronic document server via a network;
a reception device configured to receive the portion of the electronic document specified and transmitted from the electronic document server; and
a printing device configured to print the electronic document received.

3. The networked printing system as claimed in claim 1, wherein said portion designating device includes ten-pad keys provided in the printing device.

4. The networked printing system as claimed in claim 2, wherein said portion designation information generating device includes ten-pad keys provided in the printing device.

5. The networked printing system as claimed in claim 2, wherein said reading device serves as the portion designation information generating device by reading portion designation information from the book.

6. The networked printing system as claimed in any one of claims 1 and 2, wherein said electronic document server specifies the electronic document by referring to header information of each of the plurality of electronic documents.

7. The networked printing system as claimed in claim 2, wherein said electronic document server specifies the portion of the electronic document by referring to header information of each of the plurality of electronic documents.

8. A method of downloading and printing an electronic document from an electronic document server, comprising the steps of;
uniquely identifying a plurality of electronic documents of books using an identification code;
storing the plurality of electronic documents in a database in the electronic document server;
reading identification information included in a book;
converting the identification information into a corresponding identification code;
designating a portion of the book;
storing information of the portion;
transmitting a request for a prescribed electronic document and a corresponding identification code to the electronic document server via a network;
specifying and allowing download of a prescribed electronic document matching with the identification code at the electronic document server site;
receiving an electronic document specified and transmitted from the electronic document server; and
printing a portion of the electronic document corresponding to the portion.
